(19) United States
(12) Patent Application Publication
(10) Pub. No.: US 2026/0318341 A1
(43) Pub. Date: Oct. 15, 2026

(54) Actuated Shaft Mechanism

(71) Applicant: Jomoko Graves, Toledo, OH (US)

(72) Inventor: Jomoko Graves, Toledo, OH (US)

(21) Appl. No.: 19/321,236

(22) Filed: Sep. 7, 2025

Related U.S. Application Data
(60) Provisional application No. 63/723,307, filed on Nov. 21, 2024.

(51) Int. Cl. F16B 7/10; A63H 33/00

(52) U.S. Cl. CPC F16B 7/105; A63H 33/009

(57) ABSTRACT

A toy lightsaber is provided with an improved actuated shaft mechanism. The mechanism is equipped with at least one flex spring actuated locking mechanism. This mechanism securely locks the extended section of the light tube in place, preventing accidental retraction. The design offers a compact, reliable, and user-friendly solution that enhances the overall performance and durability of the toy lightsaber.

### CROSS-REFERENCE TO RELATED APPLICATIONS

Not applicable.

### STATEMENT REGARDING FEDERALLY SPONSORED RESEARCH OR DEVELOPMENT

Not Applicable.

### THE NAME THE PARTIES TO A JOINT RESEARCH AGREEMENT

Not Applicable.

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable.

### STATEMENT REGARDING PRIOR DISCLOSURES BY THE INVENTOR OR A JOINT INVENTOR

With respect to the claimed invention: (1) no disclosure was made by the inventor or joint inventor or by another who obtained the subject matter disclosed directly or indirectly from the inventor or a joint inventor; or (2) the subject matter disclosed had not, before such disclosure, been publicly disclosed by the inventor or a joint inventor or by another who obtained the subject matter disclosed directly or indirectly from the inventor or a joint inventor.

### BACKGROUND OF INVENTION

### (1) Field of Invention

The invention pertains to toy retractable lightsabers. More specifically, the invention pertains to an internal telescopic light tube micro shaft with a flex and/or spring actuated locking mechanism to lock in place a telescoping light tube section of a toy lightsaber device. That is fitted to the light tube's base and/or hollow section.

### (2) Description of Related Art including information disclosed under 37 CFR 1.97 and 1.98

Shafts with spring loaded locking mechanism assemblies as mechanical devices have for many decades allowed continuous ability to secure into place doors, locks, shelves, tools, machinery and any number of things all while inhibiting motion in the opposite direction. These mechanisms are commonly used in daily day to day life and have advanced over the years and to now traverse over to securing into place hollow light tubes of a toy retractable lightsaber.

Shafts and locking mechanisms assembly thereof generally consists of a round hollow shaft with a spring-loaded locking arm called a plunger, bolt or latch that engages the surface, bore or hole of the receiving end and/or pivoting point. The latches usually have a retracted position and engaged position.

### BRIEF SUMMARY OF CURRENT ART

The present invention relates generally to toy retractable lightsabers and more particularly, to an actuated shaft mechanism with a flex and/or spring actuated locking mechanism to lock in place a telescoping light tube section of a toy lightsaber device.

That of which is fitted to the light tube's base and/or hollow section.

Current art in the field of toy lightsabers primarily focuses on simple telescoping mechanisms that rely on friction or gravity to hold extended sections in place. These designs often suffer from issues such as accidental retraction, loose fit over time, and difficulty in extending and retracting the light tube.

While some existing designs incorporate friction locking mechanisms, these are typically bulky, complex, or require manual operation. Therefore, quantifying the value that there is a need for a compact, reliable, and user-friendly locking mechanism that can automatically and securely hold the telescoping sections in place without compromising the overall aesthetic appeal of the toy lightsaber.

A common example of where an actuated shaft mechanism would be operated is in a fully automatic toy lightsaber designed to mimic the iconic weapon from the Star Wars franchise. When the lightsaber is in its shortened, stored state, the light tube is compact. To extend the lightsaber, the user typically activates a mechanism that allows the inner section of the light tube to slide outward, increasing the overall length of the blade.

An actuated shaft mechanism within the light tube ensures that the extended section remains securely in place, preventing accidental retraction. This mechanism may include, but is not limited to a small disc-like structure with a flex and/or spring actuated latch that has an engaged and retracted position. Further, including a borehole that may be selectively threaded for telescoping capabilities along the drive axis of a threaded shaft of the lightsaber's complex system that engages with the surface, groove, hole, bore or notch in the inner tube.

### BRIEF DESCRIPTION OF DRAWINGS

FIG. 1 Illustrates an embodiment of a dimensional perspective view of the actuated shaft mechanism: (1) Actuated shaft mechanism assembled with (2) at least one flex spring latch mechanism, (3) borehole, (4) at least one flex spring latch mechanism housing track, (8) opening.

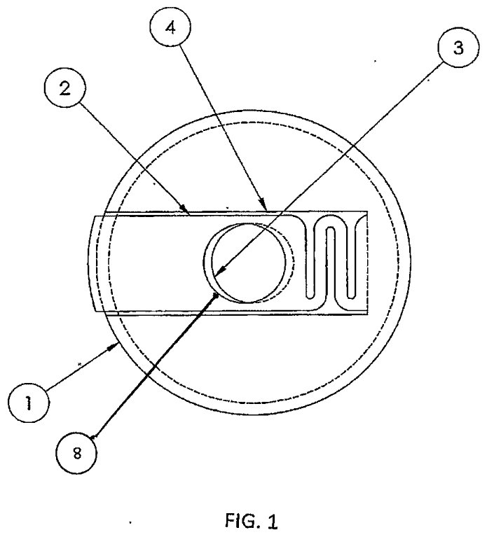

FIG. 2 Illustrates an embodiment of a dimensional perspective view of the actuated shaft mechanism: (1) Actuated shaft mechanism assembled with (2) at least one flex spring latch mechanism, (3) borehole, (4) at least one flex spring latch mechanism housing and track, (8) opening.

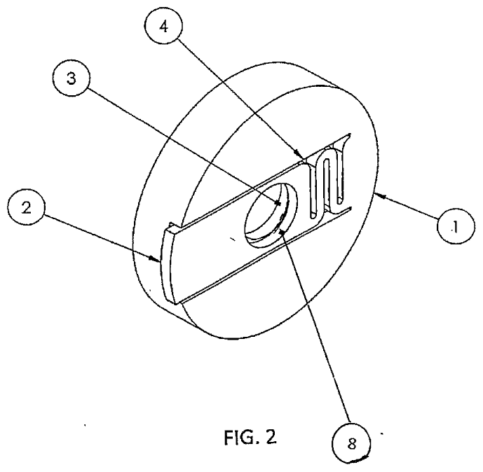

FIG. 3 Illustrates an embodiment of a dimensional perspective view of the actuated shaft mechanism: (1) Actuated shaft mechanism assembled with (2) at least one flex spring latch mechanism, (3) borehole, (4) at least one flex spring latch mechanism housing and track, (5) toy retractable lightsaber tube section, (6) threaded drive of the toy retractable lightsaber, (7) surface of the lower toy retractable lightsaber tube section, (8) opening.

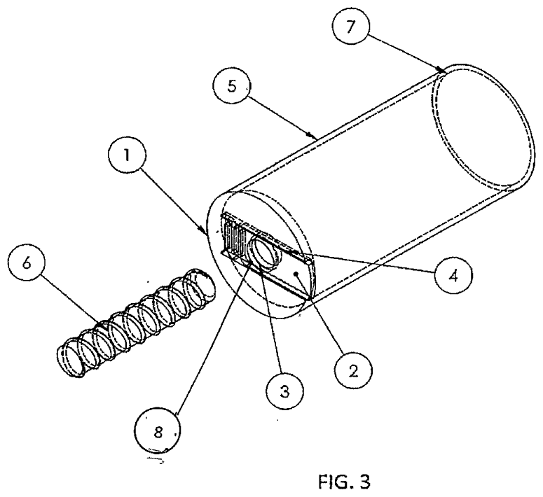

FIG. 4 Illustrates an embodiment of a dimensional perspective view of the actuated shaft mechanism: (1) Actuated shaft mechanism assembled with (2) at least one flex spring latch mechanism, (3) borehole, (5) toy retractable lightsaber tube section, (7) surface of the lower toy retractable lightsaber tube section, (8) opening.

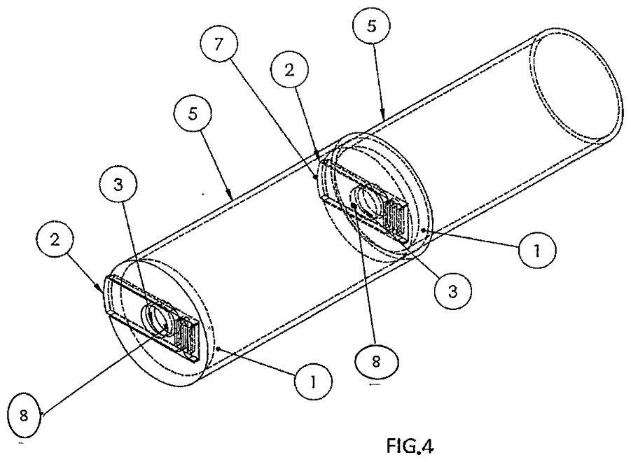

### DETAILED DESCRIPTION OF THE INVENTION

The invention relates to an 1 actuated shaft mechanism that is coupled to a 5 telescoping tube section of a toy retractable lightsaber. The mechanism enables the lightsaber to extend and retract smoothly. The 1 actuated shaft mechanism is driven along the longitudinal axis of a 6 threaded drive within the toy lightsaber's hilt. The primary purpose of this mechanism is to provide a reliable way to lock the 5 toy retractable lightsaber tube section in its fully extended, or optimal, position and to release it when it needs to be retracted. This is accomplished by a 2 flex spring latch mechanism that interacts with the 7 surface of the lower lightsaber tube section. The entire mechanism is housed within the main lightsaber body, making it an integrated and compact solution for toy lightsaber operation.

The core of the 1 actuated shaft mechanism is a 3 borehole which allows the mechanism to move along the longitudinal axis of the 6 threaded drive. This 3 borehole is essentially a channel through the center of the 1 actuated shaft mechanism that is dimensioned to receive the 6 threaded drive of the toy lightsaber. As the 6 threaded drive rotates, it engages with the inner surface of the 3 borehole, causing the entire 1 actuated shaft mechanism to travel up or down. This linear motion of the 1 actuated shaft mechanism is what directly controls the extension and retraction of the 5 toy retractable lightsaber tube section. The controlled movement ensures that the 5 toy retractable lightsaber tube section extends and retracts in a predictable and smooth manner, reducing the risk of jamming or misalignment.

The 2 flex spring latch mechanism is the key component for locking the lightsaber blade and/or 5 toy retractable lightsaber tube section in place. This mechanism is strategically placed within a 4 flex spring latch mechanism housing and track, which ensures its 8 opening stays aligned and off-center with the 3 borehole of the 1 actuated shaft mechanism. When the 5 toy retractable lightsaber tube section reaches its fully extended position, the 6 threaded drive fully traverses the 3 borehole of the 1 actuated shaft mechanism and the 8 opening of the 2 flex spring latch mechanism. This action causes the 2 flex spring latch mechanism to be actuated into an engaged position. In this engaged position, the mechanism is configured to make contact with the 7 surface of the lower lightsaber tube section, thereby locking it in its optimal position. This locking action provides the satisfying feeling of a fully extended blade and prevents it from accidentally retracting during play.

The 2 flex spring latch mechanism and/or its 8 opening is designed to be off-center from the 3 borehole of the actuated shaft mechanism, allowing it to effectively interact with the 7 surface of the lower toy retractable lightsaber tube section. This off-center placement ensures that the latch can engage with and disengage from the designated 7 surface of the lower toy retractable tube section without interfering with the movement of the 6 threaded drive within the 3 borehole. When the user initiates the retraction of the lightsaber, the 6 threaded drive begins to move in the opposite direction. This reverse movement of the 6 threaded drive disengages the latch, pulling the 2 flex spring latch mechanism into a disengaged position. In this disengaged position, the latch is retracted from making contact with the 7 surface of the 5 lower lightsaber tube section, allowing it to retract back into the hilt.

The 4 flex spring latch mechanism housing and track plays a crucial role in the proper functioning of the entire system. This component holds the 2 flex spring latch mechanism in line, preventing any rotational or lateral movement that could impede its ability to engage or disengage properly. By guiding the latch, the 4 flex spring housing and track ensure that the movement is precise and repeatable, contributing to the overall durability and reliability of the toy. The integrated design of the 1 actuated shaft mechanism, the 3 borehole, the 2 flex spring latch mechanism with its 8 opening, and its 4 housing and track work in concert to create a smooth, efficient, and robust system for extending and retracting the 5 telescoping tube section of a toy lightsaber.

What is claimed is:

1. An actuated shaft mechanism operatively coupled to a telescoping tube section of a toy retractable lightsaber, comprising:
a borehole;
at least one flex spring latch mechanism;
at least one flex spring latch mechanism housing and track;
wherein said the borehole enables the actuated shaft mechanism to be driven along the longitudinal axis of a threaded drive of a toy lightsaber;
wherein said the at least one flex spring latch mechanism is configured to actuate when the threaded drive of the toy retractable lightsaber traverses the borehole of the actuated shaft mechanism;
the at least one flex spring latch mechanism is actuated into an engaged position when the toy retractable lightsaber tube section is in its optimal position;
the at least one flex spring latch mechanism is configured to be off-center from the borehole;
wherein the engaged position of the at least one flex spring latch mechanism is configured to make contact with a surface of the lower toy retractable lightsaber tube section;
wherein said the at least one flex spring latch mechanism is actuated into a disengaged position when the toy retractable lightsaber tube section is in a retracted position;
wherein the disengaged position of the at least one flex spring latch mechanism is configured to be retracted from making contact with the surface of the lower toy retractable lightsaber tube section;
wherein said the at least one flex spring latch mechanism housing and track holds the at least one flex spring latch mechanism in line.

2. The actuated shaft mechanism according to claim 1, further comprising:
at least one flex spring latch mechanism containing an opening configured to receive a threaded drive of the toy retractable lightsaber.
